(19) United States
(12) Patent Application Publication
(10) Pub. No.: US 2003/0096671 A1
(43) Pub. Date: May 22, 2003

(54) Electroncally controlled shift-on-the-go transmission

(75) Inventors: John H. Tanzer, Punta Gorda, FL (US); Rex R. Corless, Sterling Heights, MI (US)

Correspondence Address: David W. Okey, BRINKS HOFER GILSON & LIONE, P.O. Box 10395, Chicago, IL, 60610, US

(73) Assignee: Visteon Global Technologies, Inc.

(21) Appl. No.: 09/989,208

(22) Filed: Nov. 19, 2001

(51) Int. Cl. F16H 3/52

(52) U.S. Cl. 475/300; 475/311

(57) ABSTRACT

An auxiliary transmission in series with a first automotive transmission adds extra gears through an underdrive feature, which may be manually controlled by an operator or automatically controlled by a computer or controller. The extra gears are useful in matching the output torque of the engine and the transmission to the load on the automobile or vehicle powered by the transmission, and thereby improves fuel economy and transportation performance. The transmission may be installed as factory equipment, or may be added later, such as an after-market or dealer-installed option.

### BACKGROUND

It is desirable to have as many combinations of gears as possible in the transmissions of motor vehicles, and especially vehicles that will have heavy loads, large amounts of cargo or trailers being towed. In such vehicles, a range of gears can more readily supply needed torque and speed to the wheels, rather than being forced into a more narrow range of gears. In a narrow range of gears, the transmission/axle combination cannot follow optimal engine fuel economy characteristic curves, lessening fuel efficiency. The alternative may be a transmission/axle combination in which too little or too much torque is supplied; the performance of the vehicle suffers and lugging may occur, along with loss of fuel efficiency.

These difficulties can be overcome by increasing the number of gears, especially the forward gears, in a vehicle transmission. To improve fuel economy and performance of a powertrain equipped with a multiple-speed transmission, attempts are being made to increase the number of forward speed ratios produced by the transmission. Adding gears broadens the span from first gear to the top gear and reduces the size of steps between gears. Small step sizes help to maintain engine speed closer to its optimal value. The transmission delivers smoother power, and the smaller steps also improve shift component durability and while improving shift quality and reducing shift jerking.

Attempts have been made to increase the number of speed ratios produced in a powertrain having an automatic transmission by adding auxiliary gearsets between the engine and the drive wheels. The most obvious place is the automatic transmission itself. However, adding more gears at the transmission is possibly the most costly method of adding gear steps, because this tends to increase the complexity of the transmission. Additional costs, such as retooling, tend to be prohibitive. As a result, attempts have focused on other areas of the powertrain, particularly axles. U.S. Pat. Nos. 5,538,482 and 5,888,165 are examples of multi-speed axles in which a gear reducer is provided, thus potentially doubling the number of forward gears available in the power train. However, these multi-speed axles are also expensive, and may not shift readily between ratios without special controls or shift modes. In addition, these axles or other methods may require a number of other devices to work properly. This is due to larger components, their greater mass/moment of inertia, and the resulting higher cost and weight. These modifications tend to make the resulting drivetrain both complex and costly.

The present invention is directed to an improved two-speed transmission useful for automobiles and automotive applications, as well as off-road vehicles, marine drives, and so forth. The improvement provides smaller steps between gears in a transmission, retaining vehicle performance and fuel economy while facilitating driver operation of the transmission.

### BRIEF SUMMARY

The present invention provides a two-speed auxiliary transmission between a transmission and an axle/differential. The transmission includes an input shaft and an output drive shaft. The input shaft is rotatably connected to a planetary transmission, which has at least one planet gear and a sun gear. The output shaft is splined and is coupled through power transmission elements to the planetary transmission. The sun gear is part of a coupler sleeve slidable between two positions in the transmission. A gearshift assembly powered by an electric motor and its gear reduction train powers a shifter pivotally connected to the sleeve for shifting between the two positions. Upon a signal from an electronic controller or an operator, the motor moves the shifter, a shift fork mechanism, activating the sleeve, and engaging the coupler sleeve/sun gear. In a first position, the coupler sleeve is in geared contact with a splined planet carrier, forcing the sleeve and sun gear and thus the output shaft to rotate at the same speed as the input shaft. In a second position, the sleeve and sun gear is in geared contact with a stationary gear, and the sun gear cannot rotate. This forces the planets and their pinions and housings to rotate about the sleeve and sun gear in a speed ratio dependent on the input ring gear and the sun gear. The output shaft then rotates at a speed dependent on this ratio. In one embodiment, the output speed is reduced by a factor of 1.4, that is, the output shaft rotates at 1 revolution for every 1.4 revolutions of the input shaft from a main transmission or from the engine. Other ratios may be used.

A computer, such as an engine control unit, may automatically assist in shifting the auxiliary shift-on-the-go transmission from one position to the other in one embodiment, as though the transmission had twice as many gears as the main transmission. In other embodiments, the driver or operator may decide to use the extra gears provided by the auxiliary transmission and may use the controls to shift. The computer will receive readings of the input and output speeds of the combined transmissions. The computer may receive rpm readings from sensors operative to sense the rotational speed of the input to the shift-on-the-go transmission, that is, the output from the main transmission and from the output of the auxiliary transmission. The computer is part of a more general control system that controls the shifting of the two-speed transmission. The control system may include the computer, the sensors that track the input and output speeds of the two-speed transmission, a memory with a control algorithm or look-up table, a position sensor, and operator controls, such as a switch or a button that allows the operator to begin an upshift or a downshift. Other sensors and control features are also possible.

As will be readily understood, these readings may be direct or may be inferred from other speeds, such as wheel speeds or axle-shaft speeds. The computer may also receive a speed indication from the drive shaft of the vehicle. Upon receipt of a signal from the vehicle operator to shift from normal drive to underdrive, the computer may then cause the transmission to shift from an engaged position in normal drive to a neutral position, in which gears on the sleeve are not engaged. The controller may then cause the engine to decrease its speed so that the output of the auxiliary transmission is synchronous or nearly synchronous with the input from the main transmission upon shifting from normal drive to underdrive. The computer will then control the completion the shift and the transmission will engage the underdrive position, driving the vehicle. The process will be reversed when the driver wishes to shift from underdrive to normal driving range.

### BRIEF DESCRIPTION OF SEVERAL VIEWS OF THE DRAWINGS

FIG. 1 is a schematic view of a vehicle and its control system.

FIG. 2 is a cross-sectional view of a direct drive embodiment of a 2-speed transmission.

FIG. 3 is a cross-sectional view of an underdrive embodiment of a 2-speed transmission.

FIG. 4 is a cross-sectional view of another direct drive 2-speed transmission.

FIG. 5 is a cross-sectional view of an embodiment of an underdrive 2-speed transmission.

FIG. 6 is a cross-sectional view of another embodiment of the invention.

FIG. 7 is a cross-sectional view of another embodiment.

FIG. 8 is a lower-cost version of the two-speed auxiliary transmission.

FIG. 9a is a side view of the embodiment of FIG. 8, showing its shift-control mechanism.

FIG. 9b is a front view of the shift fork and a detent for the embodiment of FIG. 8.

FIG. 10a is a side view of a shift fork-activating shaft with a torsion-spring assist.

FIG. 10b is an axial view of a shaft used in the embodiment of FIG. 10a.

FIG. 11 is a block diagram of a shift-control algorithm for the two-speed shift-on-the-go transmission.

### DETAILED DESCRIPTION OF PRESENTLY PREFERRED EMBODIMENTS

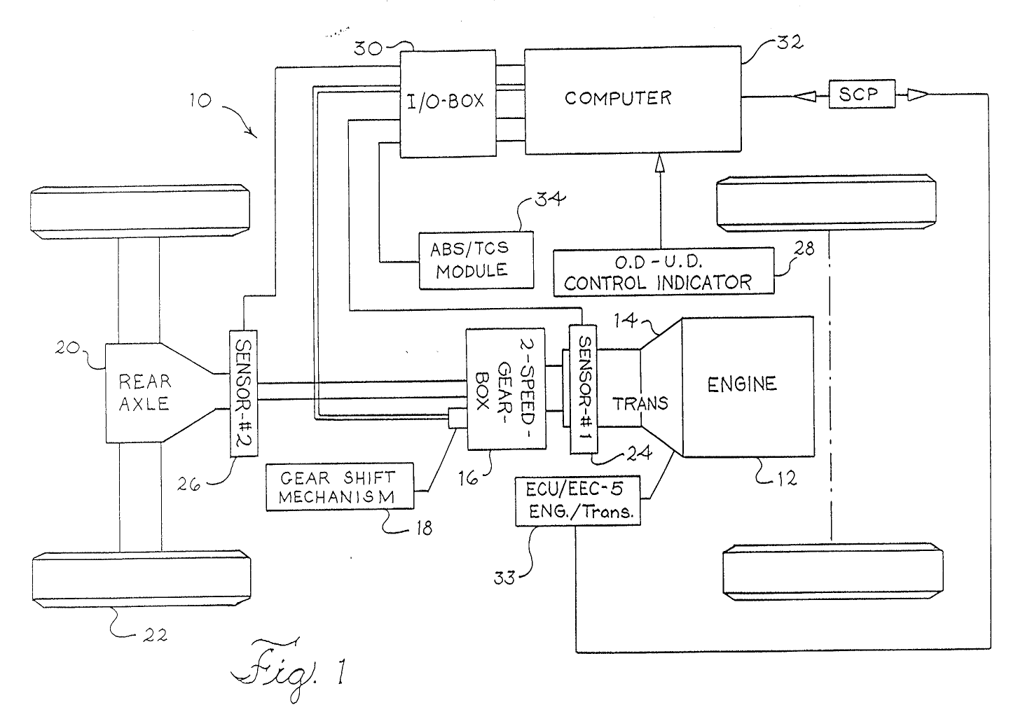

FIG. 1 depicts a vehicle 10 having a drivetrain with an engine 12, a main transmission 14, and an auxiliary transmission 16, the auxiliary transmission having a gear shift mechanism 18, and the drivetrain also having a rear axle 20 with a differential providing power to wheels 22. A transmission output shaft speed indicator or sensor 24 and a rear axle input speed indicator or sensor 26 provide necessary inputs to an on-board computer 32, which may receive the inputs from an intermediary board or I/O box 30. The computer may comprise one or more processors that control the engine directly or through an engine control unit 33 (ECU) to control the engine and the transmission. The vehicle may also have a direct-drive-under-drive switch and position indicator 28 as to whether the two-speed auxiliary transmission is in a direct or an underdrive position. The switch may control the selection of direct-drive or under-drive manually or automatically. Other electronics, such as an engine control unit/electronic engine control ECU/EEC-5 33, or antilock braking system/traction control system (ABS/TCS) 34 or automatic transmission controls may be utilized to improve the synchronization of the auxiliary transmission.

The computer that is used to receive inputs from the speed indicators 24, 26 and the position indicator 28 and to control the shifting of the auxiliary transmission may be any computer, processor, microprocessor controller, or controller that is suitable and known in the art. The electronic control unit may be added to satisfy vehicle requirements or may be of the “add-on” type if the functions are compatible with existing vehicle control units, such as the engine control unit, the antilock brake system/traction control system, or the automatic transmission controls.

The sensors and controls provided are necessary to match the speeds of the input and output shafts so that the operator and the controls may smoothly and synchronously shift from direct-drive to under-drive, or from under-drive to direct-drive. In one embodiment, the direct drive provides a 1:1 ratio of input shaft speed to output shaft speed, while the under drive provides for a 1:1.4 reduction in speed of the input shaft to the output shaft, allowing for greater torque and pulling capability without sacrificing performance or economy of operation.

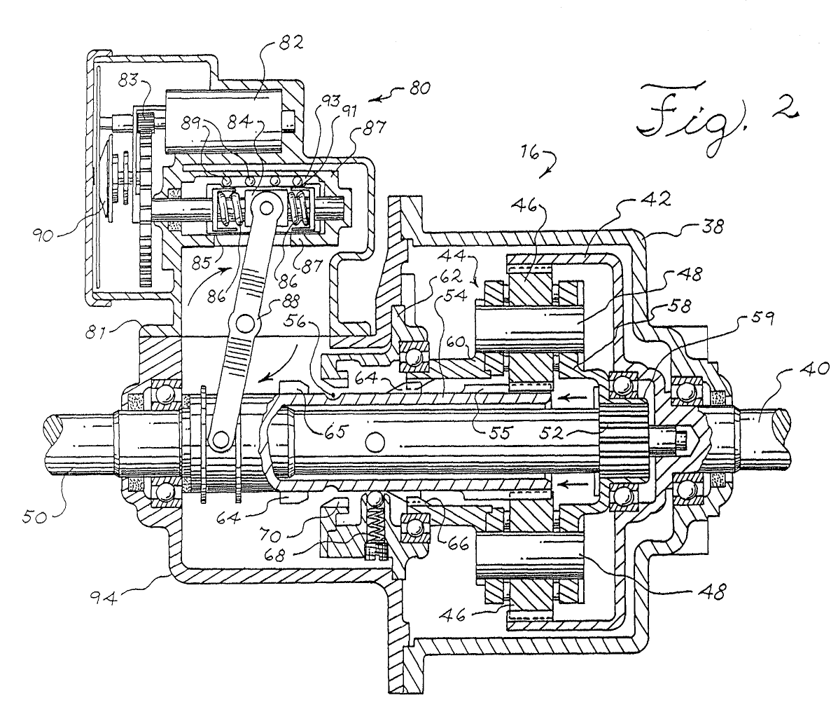

FIG. 2 depicts one embodiment in which a small, very cost-effective electric motor and a ballscrew are utilized for a highly responsive shift mechanism. The transmission 16 includes housing 38, an input shaft 40 and an output shaft 50. Output shaft 50 has a splined far end 52 inside the housing that mates with matching gear teeth 59 on planet carrier 58. In this embodiment, the input shaft is fabricated with an internal ring gear 42 which transfers power to planetary transmission 44. The planetary transmission 44 includes at least one planet gear 46, and at least one planet pin 48. In one embodiment, there are four planet gears and four pins inside ring gear 42. This figure depicts the 2-speed transmission in a direct-drive mode, with sleeve 54 shifted to the left, in the direction of the arrow. In this position, the entire planetary transmission rotates, including sleeve 54 with its splined sun gear 55. The planet pins are supported by planet carrier components 58 and 60, which may be one or more than one piece and are supported by bearings. The 2-speed transmission also houses two female splines or coupling splines 66 and 70, which mesh with matching splines 64 and 65 which are part of sleeve 54. Sleeve 54 with sun gear 55 is preferably held in place radially by a radial (sleeve) bearing and axially by a thrust bearing. While a combined sleeve and sun gear is preferred, a separately manufactured gear may also be mounted on the sleeve in a manner that prevents rotation of the gear with respect to the sleeve, for instance, by using an interference fit, flats, or pins.

In the direct drive position, the sleeve 54 with its sun gear mates through splined or mounted external conical spline helical gear 64 with internal spline 66 that is part of the planet carrier and is rotatably mounted to the housing 62 through a bearing. In this position, the sun gear or sleeve is free to rotate with the planetary transmission and the output shaft. The ring gear rotates with the input drive shaft. The input drive shaft causes the planetary assembly to rotate. Since the planets are in gear contact with the sun gear or sleeve, it turns also, as does the output shaft, which turns with the carrier 58. Thus, this position is in “direct drive,” since the output shaft, the sun-gear/sleeve, and the input shaft all rotate at the same speed. The embodiment also includes a circumferential groove 56 on the sleeve, and a detent 68 for locking the sleeve into the direct or the underdrive position. An additional groove may be used with the detent for locking the sleeve axially in the normal drive position. Rather than a circumferential groove, other locking or retaining features may be used, such as a depression in the circumference of the sleeve, or a notch in the sleeve. Rather than a helical-spring compression-loaded ball detent, other detents may be used, such as a leaf spring with a ball or wedge, the wedge nestling in a groove of matching or appropriate shape in the sleeve circumference.

A gear shift assembly 80, in flange-mounted housing 81, and shift motor 82, in conjunction with the electronic engine and shift motor control 32, act according to a shift control algorithm to synchronize inputs and outputs to the auxiliary transmission, and thus obtain smooth shifting. The unique gearshift assembly consists of the shift motor 82, a shift torque increasing gear set 83 and an axial shift position sensor 90, such as an encoder. The axial gearshift force is further increased by a ball screw nut 84 and snap action springs 86 on either side of the ball screw, acting on the pivoting shift fork 88. The ball screw nut 84 and springs 86 are contained within an inner sleeve 85 that may travel longitudinally within a stationary outer sleeve 87. Balls or other keys 89 may fit into a slot 91 in the outer surface of the inner sleeve 85 and a matching slot 93 in the inner surface of outer sleeve 87. The balls or keys allow longitudinal translation of the inner sleeve within the outer sleeve, but prevent rotation of the inner sleeve with respect to the outer sleeve. The rotation of the motor 82 and gear train 83 is thus transmitted to the ball screw nut 84 but not to the inner sleeve 85 and outer sleeve 87.

The combined sun gear coupler and shift sleeve 55 is supported by radial sleeve bearings and axial thrust bearings (not shown). The shift position sensor identifies the axial location of the sleeve, supplying information to the electronic control module for initiating and controlling the shifting process. This control includes controlling the axial shifting speed and the force in conjunction with the snap action springs to obtain a smooth gearshift. The axial shift position sensor may also be a microswitch, an optical sensor, a Hall-effect sensor, or other device that indicates whether the sleeve is in the direct-drive position or the under-drive position. The sensor is in sensory contact with a computer or microprocessor controlling the two-speed auxiliary transmission.

The ballscrew and the pivot fork in this embodiment are a “shifter,” a device flexibly connected to the sleeve on one end and to the gearshift assembly on the other. Other shifters will be seen in the examples and embodiments below, and may include ballscrews mounted directly via a coupling to the sleeve, or a ballscrew mounted to a pivot fork mounted on trunnions, the pivot fork connected to the sleeve. In other embodiments, a motor may drive a shifter which is a collar assembly mounted via a shift fork to the sleeve wherein the motor is mounted through its gear reduction train at right angles to the shift fork. The gear reduction train may then have other features to help control the shifting.

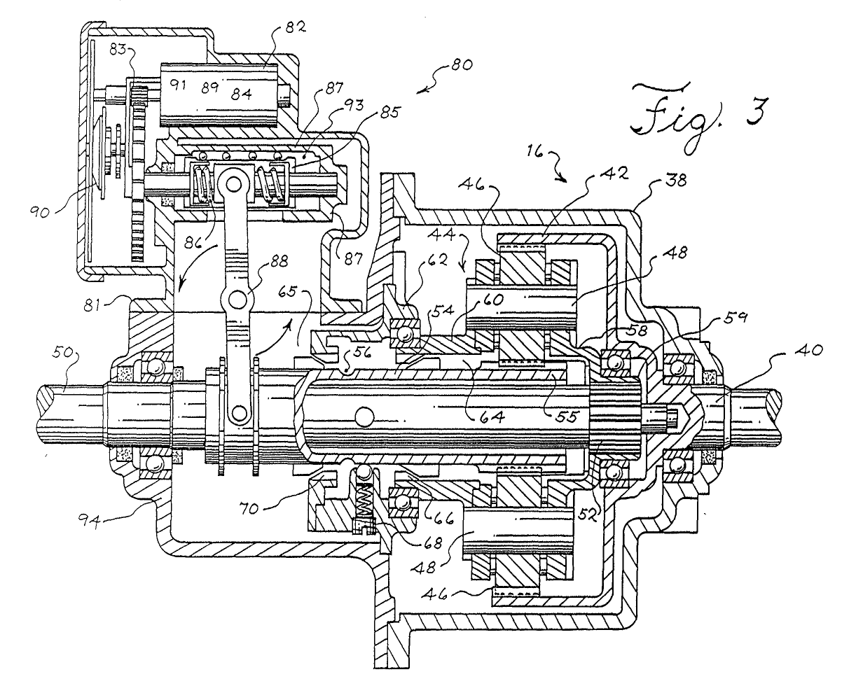

FIG. 3 depicts the 2-speed transmission initially in the “neutral plus” position, having begun a shift in the direction of the arrow, to the right. In this position, the electronic controller or microprocessor or the operator has activated the gearshift mechanism 80 to shift the sun-gear coupling sleeve 55 toward the underdrive position, via a pivoting shift fork 88. Flange mounted housing 81 contains an axial shift position sensor 90, such as an encoder, and a motor 82 and gear train 83 to turn a ballscrew and shift the pivoting shift fork 88. The ball screw nut 84 and springs 86 are contained within an inner sleeve 85 that may travel longitudinally within a stationary outer sleeve 87. Balls or other keys 89 may fit into a slot 91 in the outer surface of the inner sleeve 85 and a matching slot 93 in the inner surface of outer sleeve 87. The balls or keys allow longitudinal translation of the inner sleeve within the outer sleeve, but prevent rotation of the inner sleeve with respect to the outer sleeve. The rotation of the motor 82 and gear train 83 is thus transmitted to the ball screw nut 84 but not to the inner sleeve 85 and outer sleeve 87.

The sun gear and shift coupler 55 will be shifted to the right in the figure, in which the coupler spline 65 on the rear of the sleeve 55 engages fixed spline 70, after synchronization at the “neutral plus” position. Since gear 70 is fixed to the housing 62, the sun gear 55 is now fixed in position with respect to the input shaft and the input ring gear 42. The input shaft and its ring gear continue in gear contact with the planets 46. The planets 46, their pins 48 and their carrier 58 now rotate in accordance with their gear ratio with respect to the ring gear. Planet carrier 58 with internal spline 59 is in gear contact with the output shaft 50 through its external spline 52 at the inside end of the output shaft. In this underdrive position, the gear reduction takes place through the action of the ring gear and its pitch diameter relative to the sun gear used. The sun gear and sleeve 55 is held in its stationary position axially by circumferential groove 56 and detent 68, and rotationally by stationary internal spline 70 mounted to the housing 62. In this underdrive position, the vehicle of which the transmission is a part may now enjoy greater output torque through the output drive shaft, useful for pulling heavier loads or for climbing steeper grades, with better fuel economy.

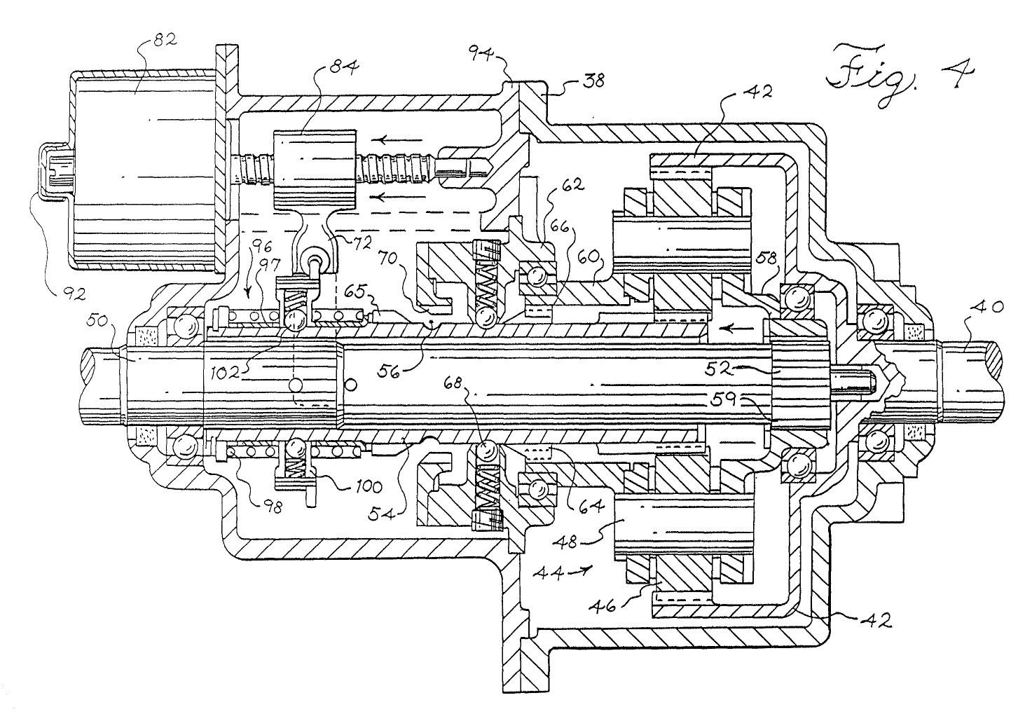

FIG. 4 depicts another embodiment, in which the pivot fork is replaced with a direct acting shift motor, an integrated ballscrew nut within the shift fork, and a snap-action spring-assist mounted with the shift collar and sleeve assembly. FIG. 4 is shown in the direct drive position, in which sleeve 54 is shifted left, in the direction of the arrow. FIG. 4 again shows an auxiliary transmission with a housing 38, 94 and an input shaft 40 and an output shaft 50. Output shaft 50 is splined at the input end 52 so as to lock to internal spline 59, part of planet carrier 58. The input shaft 40 is spline-connected to ring gear 42 that interacts through its gear teeth with a planetary transmission 44. Planetary transmission 44 includes at least one planet gear 46 and its planet pin 48, mounted to planet carrier 58. In this embodiment, the auxiliary transmission also includes a rotating coupling spline 66, which is part of the planet carrier, meshing with a coupler spline 64 on sleeve 54. In this depiction, sleeve 54 with external spline 64 meshes with rotating spline 66 but not with fixed female spline 70. As described above, in this direct drive position, the sleeve and sun gear turns with the planet carriers and the input shaft, and thus the output shaft turns at the same speed as the input shaft. This embodiment includes a ball screw drive 84 with an electric shift motor 82 and a position sensor 92, such as an encoder. The ballscrew has a direct acting shift fork link 72 to the shift collar assembly 96, mounted on the sleeve 54, which includes a spacer bushing 97, two snap-action springs 98 and shift pre-loading detents 100 pre-loading the sleeve and enabling it to quickly shift from the shown direct drive position of FIG. 4, in which the sleeve is shifted right in the drawing, to the underdrive position, depicted in FIG. 5. The shift collar assembly 96 mounts detachably to sleeve 54, and includes shift preload detents 100 engaged in circumferential groove 102 for shifting sleeve 54. The sleeve also has circumferential grooves 56 enabling position detent 68 to lock the sleeve into position in the direct and underdrive positions.

FIG. 5 depicts the same embodiment now shifted rightward into the underdrive position, the sleeve translated rightward by the electric shift motor 82 and the ball screw drive 84, assisted by springs 98, shift detent 100, and bushing 97. Detent 68 locks the sliding coupler sleeve in either the direct drive or the underdrive position with circumferential grooves 56, so that coupler spline 65, part of sleeve 54, will now engage fixed coupler spline 70, but does not engage rotating spline 66. In this position, the sleeve/sun gear cannot rotate, and the output shaft turns with a gear reduction consistent with the ratios of the planetary transmission. In one embodiment, the auxiliary transmission provides a 1:1.4 reduction in speed. In this position, the ballscrew drive 84 and shift fork 72 have shifted the sleeve 54 to the right, through snap action spring and collar assembly 96, which locks the fork and spring to the sleeve so that the shift is positive.

Note that in both FIGS. 4 and 5, the pitch selected for the ballscrew provides the additional torque multiplication to the shift motor 82, adequate for shifting gears. The ballscrew is thus acting directly on the sleeve through a non-pivoting shift fork 72.

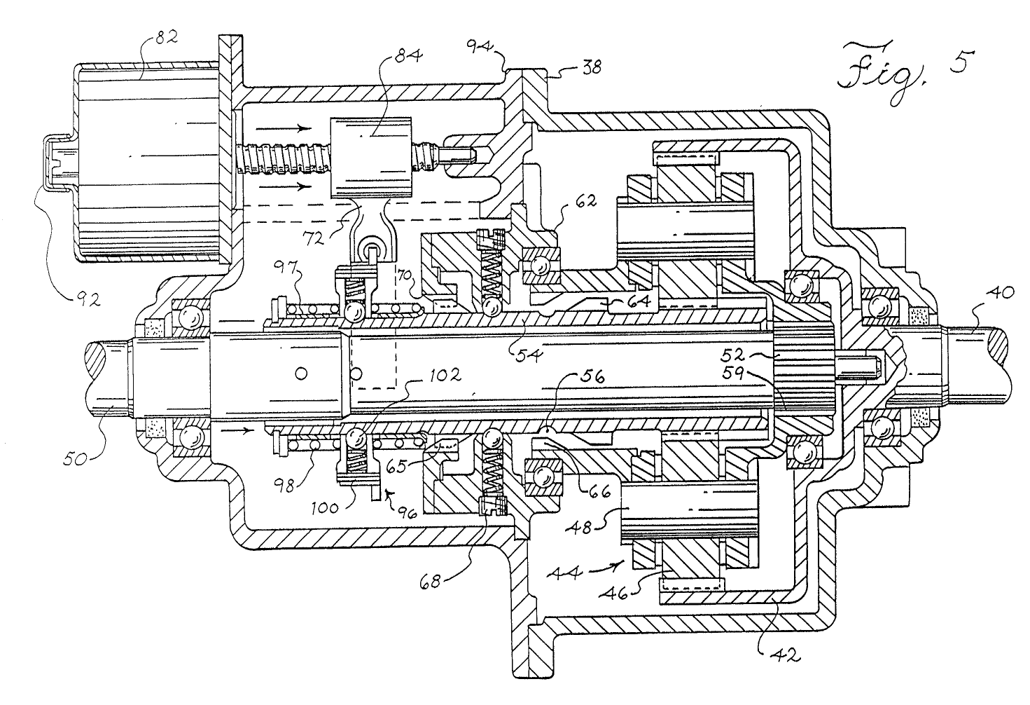

FIG. 6 depicts another embodiment of the transmission similar to FIG. 4, but having no axial preload detent in the shift collar assembly 96. A trunnion mounted pivot fork 88 mounted on pivot shaft 110 works through a ballscrew drive 84, and snap-action springs 98 reacting through collars 99 on either side of the pivot fork. The ballscrew 84 works through the pivot fork 88 to cause the sleeve 54 to shift from a direct drive position to an underdrive position. In one embodiment, sliding shift pads 112, pivotally mounted to the shift fork 88 may be used to interface to the sleeve. Snap-action springs 98 assist in quickly making the shift from one position to the other, and are also easier to assemble to the sleeve in pre-packaged form. Splines 64, 65 on the sleeve mate with female splines 66, 70. The shift collar assembly 96 includes springs 98, spacer bushing 97 and collar 99. FIG. 6 shows this embodiment in a direct drive position, with sleeve 54 shifted to the left.

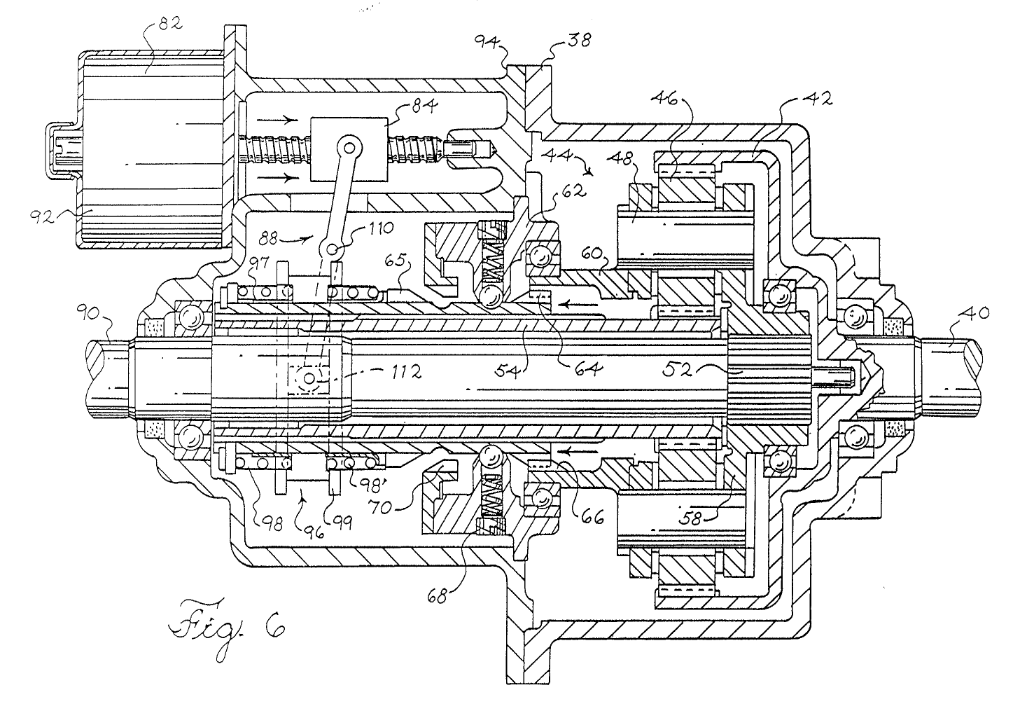

FIG. 7 depicts a simpler embodiment in which an electric shift motor 112 and an output torque-multiplying worm gear unit (not shown) that shifts the auxiliary transmission uses a pivoting shift fork 114 and collar assembly 118 to shift the sleeve 54 and thus the transmission. The collar assembly includes snap-action springs 98. The springs may be though of as biasing means that store energy and then release it when the operator or driver wishes to shift one way or the other. The biasing means then releases the stored energy and enables the operator to shift more quickly. This particular embodiment also includes a feature for ease of assembly, a flange-mounted assembly 122 that mounts the output shaft 50, sun gear bearing and sleeve bearings 124, output shaft seal bearing 126, and seal 128 on flange 130, for securing to the transmission housing 94. In this embodiment, bearing 124 provides dual-directional support for the sleeve-sleeve 54, providing axial-thrust and radial support, while bearing 126 supports and reacts output shaft 50. In addition to this simplified control for the sleeve, alignment and assembly are much easier, and can be done ahead of time, such as at a supplier's facility, saving time when a vehicle or a transmission is assembled. FIG. 7 depicts the sleeve shifted to the left, and in this embodiment, in the direct drive position.

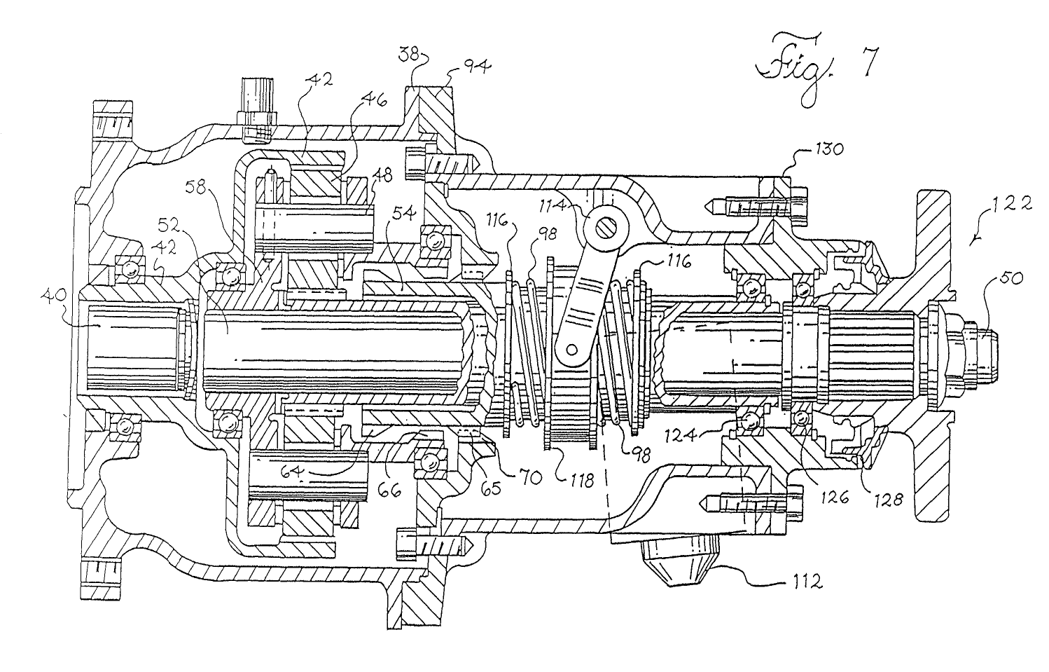

FIG. 8 is another embodiment, in which the sleeve 54 now has only a single, dual cone-shaped external coupler spline 67 for coupling to a rotating underdrive spline 70 or rotating direct drive spline 66, rather than two external coupler splines on the coupler sleeve, as shown in the previous embodiments. In addition to the cost savings, this embodiment may have an advantage for shortening the required length of the sleeve and thus the auxiliary transmission as a whole. A snap-action spring mechanism 96 shifts the sliding coupler sleeve 54 between direct and underdrive positions, in which the external coupler spline 67 engages either rotating spline 66 or stationary spline 70 as explained above. The dual cone-shaped spline teeth have been mentioned and explained in a previous patent, U.S. Pat. No. 6,785,103, assigned to the assignee of the present invention, and incorporated herein by reference. Their advantage is a greater tolerance for mis-match between the rotational speed of the input and output shafts of the auxiliary transmission when shifting to or from the direct drive position.

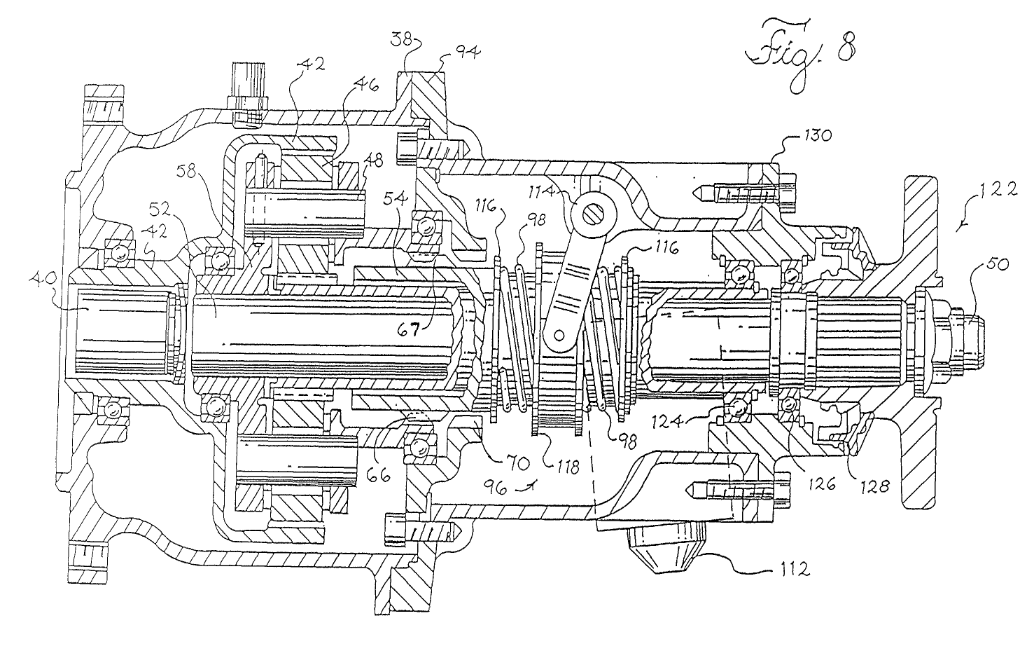

In FIG. 9a, an embodiment such as FIG. 8 shown in a cross-sectional view, features a shift motor 112 with a gear reduction train 113 acting through shaft 119 on pivot fork 114 to shift the sleeve 54. A gear-position detent 115 may be located so as to react on an extension of the shift fork 114, significantly improving axial positioning sensing through sensor 117. FIG. 9b shows such a position sensor 117 in a front view with greater detail. This Hall-effect sensor is mounted on the pivot fork and is in communication with the electronic control unit (ECU) or electronic engine control to report its position as “underdrive,” “normal drive,” or in an in-between state, depending on which position the indicator occupies. Such sensors are made by CTS Automotive Products, Elkhart, Ind., and other manufacturers. While this is a mechanical or electromechanical sensor, other sensors may be used, such as an encoder on the motor 112.

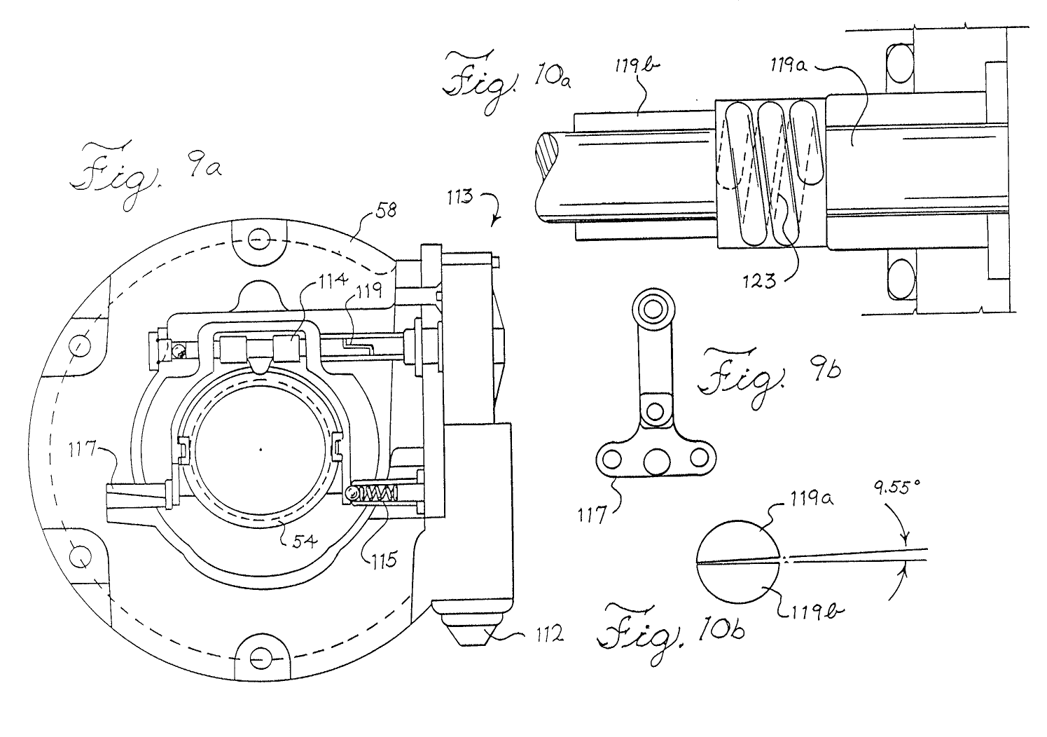

FIG. 10a depicts details of another snap action spring arrangement using torsional spring 123. This embodiment has an axially split shaft 119a, 119b acting upon the shifting fork and mounting a torsion spring 123. The axial torsion spring grounds to the input shaft 119a on one end and to the pivot shaft 119-b on its other end. In one embodiment, the shaft has a gap of about 9° 33′ (9.55 degrees) on either side of the shaft circumference. This gap limits the “spring” force available to the torsional spring. The torsional spring connects to the pivot fork shaft 119-b and acts as a snap action spring to add to the force available for a quick shift. In combination with the snap-action springs 98, it applies force to the pivot fork more quickly and allows for a reduced length collar and spring assembly interacting to shift the sleeve.

This torsional spring alternative may also be though of as a biasing means, similar to the snap action springs 98 in FIG. 8, and may help eliminate the need for such snap action springs, reducing the overall length of the transmission and improving reliability of the shift coupler position sensing. When it is time to shift, for example from direct drive to underdrive, the motor turns the split shaft through the motor gear reduction train (not shown). The torsion spring stores energy in a torsional mode until the force necessary to overcome the resistance to shifting is present. Once coupler synchronization is achieved and the lock-up portion of the shifting begins, the force stored in the torsion spring and/or the axial snap-action springs 98 is released, causing the spring(s) to release energy. This causes the shift fork and couplers to shift more quickly. Energy is stored in the spring when motor rotates one way to winds the spring in torsion. When the transmission shifts, the electric motor doing the shifting performs its task much more easily and quickly with an assist from the energy stored in the spring. While energy is continually conserved and re-used in torsion springs, it is the relatively small time savings, rather than the energy savings, that is sought here. In this embodiment, a sliding coupler sleeve having one external coupling spline 67 for interfacing with the planetary transmission, rather than two coupler splines, also reduces overall length of the auxiliary transmission.

The advantage of the invention is that the underdrive feature of the auxiliary transmission may be used automatically or as needed between gears of a standard transmission. In one method of using the invention, a driver or operator may decide that the vehicle is lugging and may benefit from the use of an intermediate gear. The operator then activates the two-speed shift-on-the-go transmission. The operator may activate the transmission by pushing a selector button, or switching a switch, to indicate to a controller that the underdrive feature is desired. In another method of using the invention, the engine controller senses automatically that the underdrive feature is needed, by comparing the speed of the transmission output with the output speed of the auxiliary transmission or the speed of the wheels or rear axle and the engine torque.

In the case of operator actuation, the operator may shift back into direct drive when a period of need for the underdrive feature has ended. Such a case may exist during acceleration, when the vehicle may first need to get to cruising speed by using the underdrive feature, followed by a steady operating regime, during which normal, direct drive will suffice. The operator controls the mode or position of the auxiliary transmission by a control mechanism, such as a switch or a button. In automatic operation, the controller automatically selects the gear in a manner similar to any automatic transmission, by sensing the engine output shaft speed and comparing it to the drive wheel or drive shaft speed, in conjunction with engine performance characteristics, and automatically selecting a gear according to its design. In the case of a transmission using an auxiliary two-speed transmission, the underdrive feature of the auxiliary transmission gives the controller an extra degree of freedom in selecting the next gear in series during acceleration or deceleration.

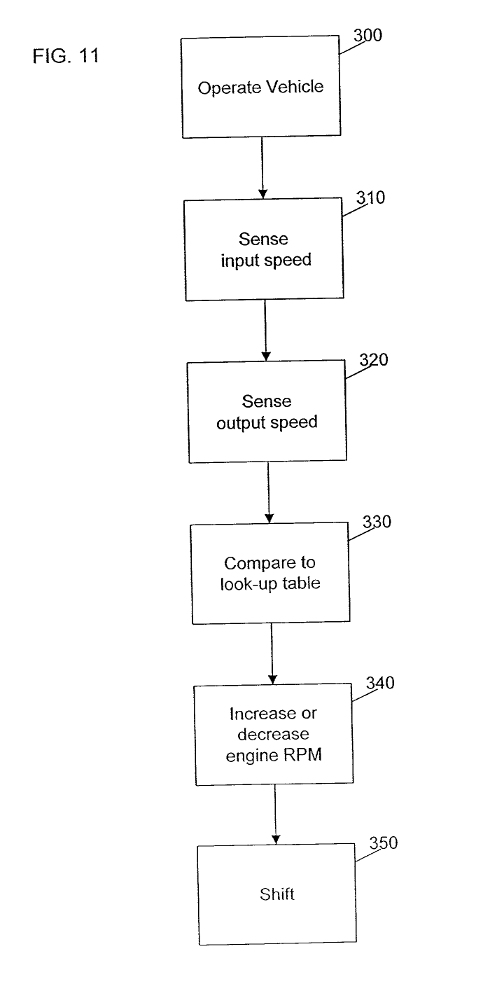

FIG. 11, to be used in conjunction with FIG. 1, is a flow diagram of a method of using the auxiliary transmission in a vehicle. In a first step, an operator starts the vehicle 300. A sensor senses the engine input speed 310, for example, in revolutions per minute (rpm). Another sensor senses output speed 320. This output may be any speed, typically rotational speed, associated with the output of the transmission, taking the primary transmission and the auxiliary transmission as a whole, the drivetrain of the vehicle. Thus, the output speed may be the output shaft of the auxiliary transmission, or it may be the speed of an axle taking the output of the auxiliary transmission, or it may be vehicle wheel speed. In one embodiment, the computer may read the output speed of the primary transmission and the position of a switch indicating the position of the auxiliary transmission, that is, whether the auxiliary transmission is in direct drive or underdrive. Any of these data may be used to calculate the actual output speed of the auxiliary transmission, and thus may be used to control the speed of the engine when it is desired to shift the auxiliary transmission from one position to the other.

The computer controlling the position of the auxiliary transmission may read the input and output speeds 320 and then match the output speed of the auxiliary transmission to the desired speed 330 before shifting from direct drive to under drive, or from underdrive to direct drive, the same but in reverse. For instance, the controller may first shift the coupler sleeve from its engagement in either the direct or underdrive positions, and the sleeve may be in a neutral position. The controller reads the speeds via sensory inputs to a control board or portion of the computer that converts the signals from the sensors to useful information enabling the computer to decide the precise moment to activate the shift of the auxiliary transmission. The controller then increases or decreases engine speed 340 or main transmission output speed to a speed or to a range specified in a look-up table stored in the memory of the computer. At the appropriate matching of speeds, the controller signals the shifting mechanism to complete the shift from neutral to underdrive. In shifting back from underdrive to direct drive, the process may be repeated in reverse. As will be recognized by those skilled in the art, an anti-lock brake system (ABS) and its inputs of wheel speed may be used to infer the output speed of the auxiliary transmission, and the ABS system may also be used to slow the wheels and thus the output of the auxiliary transmission in the neutral state when synchronizing the input and output speeds of the auxiliary transmission for shifting.

The auxiliary transmission may be installed at the factory, as an original equipment manufacturer option on a vehicle. Alternatively, an embodiment of the auxiliary transmission may be installed later as an after-market or dealer-installed option. In the case of an operator-controlled version, the installation of controls is much simpler, since the operator activates the underdrive position manually, and also shifts the transmission out of underdrive. Other obvious modifications may also have to be made, such as custom drive shafts, mounting of the auxiliary transmission, wiring of the controls, and so on. The design and installation of an automatic version for the after-market will be somewhat more complicated, in ensuring that the shift points of the combined transmissions are compatible with the new equipment, two transmissions in series, rather than a single transmission. The savings to be realized from fuel economy or from improved performance may warrant this expense, even for an automatic embodiment.

Of course, it should be understood that the foregoing detailed description has been intended by way of illustration and not by way of limitation. Many changes and alternatives can be made to the preferred embodiments described above. For example, though it is preferred to use the various improvements described above in combination, they can also be used separately from one another. Furthermore, many of the improvements of this invention can be used with other types of transmissions. For instance, while most of the embodiments have dealt with the need for improved performance under load and for better fuel economy while traveling, one embodiment of the invention may be used as well for a PTO shaft from an engine, powering an auxiliary device with a need for an auxiliary transmission. The planetary gear ratio can be easily changed to obtain optimization of the engine/transmission combination. While a reduction ratio of 1.4:1 was featured, other reductions, or even increases in ratio, are possible by simply selecting the gear ratios in the planetary transmission, the sleeve, and the input ring gear.

Such applications could include winches, augers, and other devices utilizing mobile forms of power transmission. In these embodiments, or in mobile embodiments, an engine and transmission employing the two-speed gearbox may be considered to be a power transmitter, and may be used in stationary applications, or may also be used in mobile applications, such as trucks, automobiles, and boats. In some applications, a mobile transmission employing the two-speed gearbox may link to stationary devices requiring power, such as a truck or a tractor or a combine powering an auger or a pump. Since the foregoing detailed description has described only a few of the many alternative forms this invention can take, it is intended that only the following claims, including all equivalents, be regarded as a definition of this invention.

What is claimed is:

1. A two-speed auxiliary transmission, comprising:
a two-speed gearbox having an input shaft, an output shaft, and a planetary transmission coupling the input shaft with the output shaft, the planetary transmission having at least one planet gear and a sleeve movable between two positions;
a gear shift assembly mounted externally to the gearbox, said gear shift assembly having a motor and a gear reduction train for the motor driving a shifter, the assembly operably connected to the gearbox; and
a control system acting upon the gear shift assembly and responsive to shift the sleeve between the two positions, wherein a speed of the output shaft is related to a speed of the input shaft by a first ratio in the first position and the speed of the output shaft is related to the speed of the input shaft by a second ratio in the second position.

2. The two-speed auxiliary transmission of claim 1, wherein the gearbox further comprises a rotatable coupler spline and a fixed coupler spline, the sleeve coupled to the rotatable coupler spline in the first position and to the fixed coupler spline in the second position.

3. The two-speed auxiliary transmission of claim 1, wherein the output shaft speed is related to the input shaft speed in a 1:1 ratio in the first position and in a 1:1.4 ratio in the second position.

4. The two-speed auxiliary transmission of claim 2, wherein the sleeve further comprises a sun gear and splined coupler.

5. The two-speed transmission auxiliary of claim 4, wherein the sleeve and splined coupler further comprises at least one cone-shaped external coupler spline meshing with the rotatable coupler spline in the first position and with the fixed coupler spline in the second position.

6. The two-speed auxiliary transmission of claim 5, wherein the at least one cone-shaped external coupler spline is a dual cone-shaped coupler spline.

7. The two-speed auxiliary transmission of claim 4, wherein the sleeve further comprises a single additional gear selected from the group consisting of a splined gear and a mounted gear, the additional gear meshing with the rotatable gear in the first position and with the fixed gear in the second position.

8. The two-speed auxiliary transmission of claim 4, wherein the sleeve further comprises at least on e feature selected from the group consisting of a circumferential groove, a depression, and a notch, mating with a detent in the gearbox.

9. The two-speed auxiliary transmission of claim 1, wherein the control system comprises a computer and sensors operably connected with the computer, the sensors relaying information indicative of a speed of the input shaft and a speed of the output shaft.

10. The two-speed auxiliary transmission of claim 1 wherein the gear shift assembly mounts to the shifter via at least one feature selected from the group consisting of a direct-mounted ballscrew, a pivot-mounted ballscrew, a trunnion-mounted ballscrew, a pivot fork, a shift fork, a split shaft, a torsion spring, and a direct-mounting linkage.

11. The two-speed auxiliary transmission of claim 10, wherein the shifter further comprises at least two snap-action springs.

12. The two-speed auxiliary transmission of claim 10, wherein the shifter further comprises a snap action shift collar assembly.

13. The two-speed auxiliary transmission of claim 10, wherein the gear train for a shifter further comprises an axially-split shaft mounting a torsion spring.

14. The two-speed auxiliary transmission of claim 1, wherein the sleeve further comprises a snap-action shift collar assembly having at least one spring-loaded detent.

15. The two-speed auxiliary transmission of claim 1, wherein the output shaft mounts with a flange to a housing of the gearbox.

16. The two-speed auxiliary transmission of claim 1, wherein the flange further mounts at least one bearing and a seal.

17. The two-speed auxiliary transmission of claim 1, wherein the control system is contained in a housing flange-mounted to a housing of the gearbox.

18. A method for adding speed ratios to a power transmitter having a first transmission in series with an auxiliary transmission with a gear shift assembly having at least two speeds, the method comprising:
providing the first transmission and the auxiliary transmission;
mounting the gear shift assembly externally to the auxiliary transmission;
controlling shifting of the auxiliary transmission from a first speed to a second speed, wherein speed ratios are added by shifting from a first speed to a second speed of the auxiliary transmission to raise or lower the output speed of the series; and
aiding shifting of the transmission by biasing means acting on a shifter of the auxiliary transmission.

19. The method of claim 18, wherein the biasing means are springs.

20. The method of claim 18 wherein the biasing means are torsional springs.

21. The method of claim 18, wherein controlling is provided via a computer in sensory contact with sensors indicative of a rotational speed of the first transmission and a rotational speed of the series output.

22. The method of claim 18, wherein the computer synchronizes the speeds of an output of the main transmission and an output of the auxiliary transmission before shifting.

23. The method of claim 18, wherein the power transmitter is used in an automobile, a truck, a boat, or a stationary installation.

24. The method of claim 18, wherein an operator manually controls the shifting.

25. A two-speed auxiliary transmission, comprising:
a two-speed gearbox having an input shaft, an output shaft, and a planetary transmission coupling the input shaft with the output shaft, the planetary transmission having at least one planet gear and a sleeve movable between two positions, a speed of the output shaft related to a speed of the input shaft by a first ratio in a first position and by a second ratio in a second position;
a gear shift assembly mounted externally to the gearbox, said gear shift assembly having a motor and a gear reduction train for the motor driving a shifter, the assembly operably connected to the gearbox; and
a control system acting upon the gear shift assembly and responsive to shift the sleeve between the two positions.

26. The two-speed auxiliary transmission of claim 25, wherein the control system further comprises an operator control for shifting up or down, a computer with a memory operably connected to the operator control, sensors for indicating the speed of the output shaft and the input shaft, and a sensor for indicating a position of the sleeve.

27. The two-speed auxiliary transmission of claim 25, wherein the sensor for indicating a position of the sleeve is selected from the group consisting of an encoder on the motor, and at least one position sensor.

28. A two-speed auxiliary transmission, comprising:
a two-speed gearbox having an input shaft, an output shaft, and a planetary transmission coupling the input shaft with the output shaft, the planetary transmission having at least one planet gear and a sleeve movable between two positions;
a gear shift assembly mounted externally to the gearbox, said gear shift assembly having a motor and a gear reduction train for the motor driving a shifter, the assembly operably connected to the gearbox; and
a control system comprising at least one computer and sensors relaying information to the computer indicative of a speed of the input shaft and the output shaft, the control system acting upon the gear shift assembly and responsive to shift the sleeve between the two positions,
wherein a speed of the output shaft is related to a speed of the input shaft by a first ratio in the first position and the speed of the output shaft is related to the speed of the input shaft by a second ratio in the second position.

29. A two-speed auxiliary transmission, comprising:
a two-speed gearbox having an input shaft, an output shaft, and a planetary transmission coupling the input shaft with the output shaft, the planetary transmission having at least one planet gear and a sleeve movable between two positions;
a gear shift assembly mounted externally to the gearbox, said gear shift assembly having a motor and a gear reduction train for the motor driving a shifter, the assembly operably connected to the gearbox; and
a control system acting upon the gear shift assembly and responsive to shift the sleeve between the two positions, the control system comprising at least one computer, speed sensors relaying information indicative of a speed of the input shaft and the output shaft, an operator control, and a position sensor operably connected with the computer.
